(19) United States
(12) Patent Application Publication
(10) Pub. No.: US 2016/0235080 A1
(43) Pub. Date: Aug. 18, 2016

(54) Methods for increasing the nutraceutical content of perishable fruits

(71) Applicant: CENTRO DE INVESTIGACIÓN Y DE ESTUDIOS AVANZADOS DEL INSTITUTO POLITÉCNICO NACIONAL, México, D.F. (MX)

(72) Inventors: Maria Esperanza AYALA GIL, Irapuato (MX); Edmundo LOZOYA GLORIA, Irapuato (MX)

(21) Appl. No.: 15/024,643

(22) PCT Filed: Sep. 12, 2014
(86) PCT No.: PCT/IB2014/064455

§ 371 Date: Mar. 24, 2016

(30) Foreign Application Priority Data
Sep. 24, 2013 (MX) MX/A/2013/011003

(51) Int. Cl. A23B 7/015; A23B 7/04

(52) U.S. Cl. CPC A23B 7/015; A23B 7/0425; A23L 1/0252; A23L 1/2123; A23V 2002/00

(57) ABSTRACT

The present invention relates to methods for increasing the content of nutraceuticals and antioxidant capacity of perishable fruits, by combining irradiation with ultraviolet light (UV-C) and storage at freezing temperatures in different presentations. According to the invention, it is possible to increase the concentration of flavonoids, such as phenols and anthocyanins, and also the antioxidant capacity of strawberry fruits (Fragaria x ananassa). The main objective of the present invention is to improve the postharvest quality of fruits, particularly strawberry, by stimulating strawberry fruits with different doses of UV light and different temperatures.

### FIELD OF THE INVENTION

The present invention relates to methods for increasing and preserve the nutraceutical content of food, more particularly to methods for increasing the content of flavonoids, phenols, anthocyanins, and the antioxidant capacity of perishable fruits such as strawberries (Fragaria x ananassa) by radiation with ultraviolet light (UV-C) of the fruit and subsequent storage at freezing temperatures in different fruit presentations. The main objective of the present invention is to improve the post-harvest quality of fruits, particularly strawberry, stimulating the fruit with different doses of UV light and at different temperatures.

### BACKGROUND OF THE INVENTION

Fruits are highly perishable products, especially after being harvested, where the factors that impair the quality during storage, distribution, and marketing are diverse. With the aim of improving the nutraceutical content and quality of fresh fruits and vegetables, the use of different abiotic stress has been proposed as an efficient tool to affect the secondary metabolism of fresh fruits to produce and increase the synthesis of phytochemicals with nutraceutical activity, or reduce the synthesis of undesirable compounds. These treatments include the use of phytohormones, temperature, ultraviolet light, altered gas composition, heat shock, and water stress, among others (Cisneros-Zevallos, 2003).

Phenolic compounds are a series of metabolites widely distributed in plants. Flavonoids are a subfamily of phenolic compounds and are located mainly in the fruit as flavonols and anthocyanins; their multiple biological properties and antioxidant activity make them likely candidates to explain the link between the consumption of certain plant products and a decreased risk of degenerative diseases. Nowadays, studies are being carried out in many medical fields regarding flavonoids, but they are largely focused on specific metabolites such as fisetin, quercetin, and pelargonidin, which have proven their pharmacological properties, thereby justifying the interest of analysis.

Strawberry (Fragaria x ananassa Duch.), a farming of major economic importance in Mexico, has significant amounts of anthocyanin pelargonidin, while the flavonols quercetin and fisetin, which are also present in the fruit, have been extensively investigated in pharmaceuticals; hence, the interest in studying these three metabolites individually. With the aim to increase the phenolic compounds in various fruits, post-harvest physical treatments have been used, such as radiation with UV light and freezing.

UV treatments have shown their ability to alter various aspects in different types of fruit. These treatments have made possible to extend shelf life, reduce loss, and maintain or even improve the quality of fresh produce. Usually, the time of application of UV light does not significantly increase the temperature of fruit tissue (1-3° C.), produce alterations, nor promote the deterioration process of the product. However, the tissue sensitivity to UV treatment differs depending on the genotype, physiological state, composition, and thickness of the skin of the fruit or vegetable. Therefore, high doses of UV light may contribute to the oxidation of bioactive compounds such as vitamin C, carotenoids and phenols, and browning of the tissue (Gonzalez-Aguilar et al., 2001, 2006). So, the effectiveness of UV radiation depends on many factors such as dose, light source, species, cultivar, etc. Depending on the intensity and the wavelength applied, it has been possible to observe different beneficial effects attributed to the ultraviolet light treatment of fruits, such as the inactivation of enzymes related with the ripening processes and senescence, and the induction of defense mechanisms (synthesis of phytoalexins) (Mercier et al., 1993), which are positively associated with the resistance to different pathogens, the reduction of physiological disorders occurring during cold storage, and the ability of improving nutraceutical properties owed to increased levels of bioactive compounds with antioxidant capacity.

The antioxidant activity of phenolic compounds is attributed to their ability to transfer hydrogen atoms or electrons of an aromatic hydroxyl group into a free radical, generating a more stable phenoxyl radical (Duthie et al., 2003); or to their ability to chelate metal ions such as iron and copper thereby acting as scavengers of singlet oxygen and free radicals (Rice-Evans et al., 1997). Today, this group of plant compounds is of great nutraceutical interest for their contribution to human health. The word ‘nutraceutical’, which is different from ‘nutritional’, is a term coined in the 1990's by Stephen DeFelice, and he defined it as any substance that is a food or a part of a food that provides medical or health benefits, including the prevention and treatment of disease. Over the years, several international health organizations have recommended at least 5 servings daily of fruits and/or vegetables to ensure an adequate intake of antioxidants and prevent oxidative-stress induced diseases (WHO, 1995; WCRF, 1997). Because of their great variety of activities, flavonoids, a subfamily of phenolic compounds, have attracted considerable attention to become the most studied polyphenol group in the scientific community. Flavonoids have been designated as nutraceutical compounds for their properties.

Fisetin is an important antioxidant compound playing a key role in protection against different types of cellular stress. It has been identified as anticancer and antiproliferative compound; e.g., its positive effects have been observed in human cells of prostate cancer and in different lines of breast cancer (Haddad et al, 2006), and in the inhibition of HT-29 cell cycle in human colon cancer cells (Lu et al., 2005). Fisetin has also been identified as inhibitor of AR signaling axis, which suggests that this compound can be used as chemopreventive and chemotherapeutic agent for retarding the progression of prostate cancer (Khan et al., 2008). Regarding the neuroprotective effects of fisetin, it has been proven that it stimulates neuronal activity and enhances memory via activation of the Ras-EKT cascade, inducing differentiation and maturation of neuronal cells and promoting the creation of new connections between nerve cells (Maher et al., 2006). Furthermore, it was demonstrated that fisetin can enhance proteasome activity promoting the survival of nerve cells because proteasome is involved in disorders such as Parkinson's and Alzheimer's diseases (Maher et al., 2006). Also, this metabolite reduced neurologic complications and kidney damage in a murine model of type 1 diabetes, protecting neurons from toxic elements via its antioxidant and anti-inflammatory activity. This was observed in a type 1 diabetes murine model, where diabetic and control mice were fed a dose of 25 to 40 mg/Kg of fisetin daily. Finally, in vivo tests in animals show that fisetin reduces brain damage and improves life expectancy after inducing myocardial infarction in mice.

Furthermore, studies show that quercetin, which is widely known as food coloring, has other biological properties, most prominent of which is its antioxidant capacity. According to in vitro tests, this activity prevents cardiovascular diseases (Graefe et al., 1999); it has also shown to prevent the oxidation of LDL (low density lipoprotein). Its anticancer function has been demonstrated in different activities; e.g., mitogen activated protein (MAP) kinase in human epidermal carcinoma cells was strongly inhibited by quercetin (30 μM) (Bird et al., 1992). It also regulates the synthesis of DR5 (death receptor), which is related with sensitization of prostate cancer cells to apoptosis (Jung et al., 2010). Furthermore, it has also shown to inhibit cell proliferation in several types of cancer, reducing the phosphorylation of Akt protein and gene expression of survivin (an inhibitor of apoptosis) in prostate cancer cells (Kim and Lee, 2007). Regarding its use in the prevention of cardiovascular disease, quercetin promotes platelet aggregation and relaxation of vascular smooth tissue (Formica and Regelson, 1995). Similarly, quercetin has been reported to produce antihypertensive effects and lower left ventricular hypertrophy, endothelial dysfunction, plasma, and hepatic oxidative status (Duarte et al., 2001). Moreover, this flavonol has been related to antidiabetic activities (Vessal et al., 2003) and anti-inflammatory effects modulating the biosynthesis of eicosanoids, which shows that quercetin can be one of the strongest natural anti-inflammatories. Finally, its antimicrobial and antiviral activities have also been reported, as it has shown to inhibit the growth of Staphylococcus aureus (Havsteen et al., 1983) and some of its 11 types of viruses.

Anthocyanins have also been reported to possess anti-tumor and anticancer properties. It has been proved that anthocyanins from purple sweet potato and red cabbage administered to laboratory rats suppress carcinogenesis (Hagiwara et al., 2002). Similarly, anti-tumor effects were reported when using extracts from red soy-beans containing cianidin conjugated with glucose and rhamnose (Koide et al., 1997). Regarding anticancer activity, it was found that the anthocyanin fraction from red wine suppressed the growth of HCT-15 cells and AGS cells, which were derived from human colon cancer and human gastric cancer respectively (Kamei et al., 1998). Also, bioassays were performed showing that blueberries inhibit the stages of initiation, promotion, and progression of carcinogenesis (Tristan et al., 2005). In terms of anti-inflammatory activity, it was found that concentrated extracts of anthocyanin had an inhibitory effect on the production of nitric oxide in activated macrophages (Wang and Mazza, 2002). Similarly, raspberry anthocyanins were effective against the formation of the pro-inflammatory mediator, prostaglandin EG2 (Vuorela et al., 2005). Furthermore, anthocyanins from four species of wild blueberries—Amelanchier alnifolia, Viburnum trilobum, Prunus virginian and Shepherdia argentea—showed hypoglycemic properties (Tristan et al., 2005). Another example of anti-diabetic activity of anthocyanins was reported in Italy, where it was revealed that 79% of diabetic patients consumers of red berry extract (160 mg twice daily for one month) showed a symptom relief of diabetic retinopathy. Finally, the improvement in visual acuity and cognitive behavior as a result of the consumption of anthocyanins has been reported by Ohgami et al. (2005) who administered fruit extracts rich in anthocyanins to rats with ocular deficiency. The results produced were an anti-inflammatory effect and increased visual acuity. Furthermore, Joseph et al. (1999) showed that cognitive behavior and neural functions in laboratory rats could be improved through nutritional supplementation with blueberry and strawberry extracts.

In the prior art, there is literature on the use of light as post-harvest treatment, where most of the published works are related to its effect on pathogen organisms. These works involved the study of the effect of exposure to UV (A-B-C) in both isolate organisms and those found in the surface of fruits and vegetables. Examples of effective decay control (retarded senescence and fruit deterioration) observed in different fruits irradiated with UV are tomatoes (Stevens et al., 2004), mango (Gonzalez-Aguilar et al., 2001), cranberry (Perkins-Veazie et al., 2008), peach (Stevens et al., 1998), grape (Nigro et al., 1998), pepper (Vicente et al., 2005), tangerine (Kinay et al., 2005), apple (Capdeville et al., 2002), and strawberry (Baka et al., 1999; Nigro et al., 2000; Pan et al., 2004). In the latter example, the treatment increased strawberry shelf life 4 to 5 days with fruit preserved at temperatures between 4 and 20° C.; i.e., the temperatures ranging refrigerated storage.

Furthermore, it has been reported that the pathway of phenylpropanoids has been stimulated by UV radiation; e.g., the increase of total phenols and flavonoids of 20% and 33% in mangoes irradiated at doses of 2.46 and 4.93 kJ/m² (Gonzalez-Aguilar et al., 2007). Moreover, sweet peppers (Capsicum annuum L cv. ‘Zafiro’) irradiated with UV at 7×103 kfg/s² immediately showed an increase of 11.85% in their antioxidant capacity when preserved at 10° C., where said capacity decreased both in treated and untreated fruit; but at 18 days of storage treated fruit showed a higher level (8.6%) of antioxidants (Vicente et al., 2005). In 2000, Cantos and col. disclosed that irradiating grapes with UV-B and UV-C light the concentration of resveratrol increased by the double and triple, but not the content of anthocyanins and phenols, which remained constant and, in some cases, decreased when storing the fruit at 15° C. during 10 days. Other fresh produce analyzed for the effect of UV radiation was the group of berries. This is the case of blueberry, where after irradiation it was stored during 7 days at 5° C., showing slight increases of anthocyanins and phenolics, no greater than 10% (Perkins-Veazie et al., 2008). In the case of raspberry, a combination of heat-irradiation-refrigeration treatments was analyzed both individually and in combination, showing a decrease in the fruit deterioration and a lower loss of anthocyanins, suggesting that these treatments are non-chemical options to maintain fruit quality for longer periods. Finally, there are reports of UV radiation in strawberry fruits using doses of 0.25 and 2.15 kJ/m² successfully inducing the synthesis of anthocyanins and phenols by the end of the storage at 10° C. in about 15.07 and 26.78% respectively, improving the nutritional quality of the product (Dong et al., 1995; Baka et al., 1999, and Mustafa et al., 2008).

Freezing is a widely used method for preserving plant products during storage and transport and is based on the solidification of water content in fruits and vegetables. This method can delay the loss of quality of perishable food by stopping the biological activity of the fresh produce. The freezing process does not markedly alter the aroma of fresh fruit, except if cold storage is long lasting. During storage, the fruits should be maintained within a narrow range (±1° C.) of the desired temperature; below this optimum range, some products, especially tropical fruits, may suffer cold damage. Above this range, the shelf life of the product is shortened. Freezing can be done by fast or slow methods. The slow method used for example in the present invention, subject the product (fruit, meat, fish, etc.) at low temperatures and let it freeze (Gruda and Postoski, 1986), where the temperature range is at least 1° C. to −20° C. Since air circulation generally occurs by natural convection, freezing time depends on the volume of the product and freezer conditions. For conservation effects, undesirable reactions are reduced and the product is maintained in this state during storage, so that the physical, chemical, and microbiological changes are reduced to a minimum. Therefore, it is indispensable to exactly determine the prior treatments, optimal freezing rate, type of packaging, storage temperature, and thawing rate.

The document WO2011113968 discloses a method for improving the functional properties of fruit by the use of pulsed light on biomolecules such as proteins, carbohydrates, lipids, etc. While pulsed light has a high content of UV light, there are significant differences between treatment with continuous UV light and pulsed light treatment, mainly because the pulse light comprises a broad emission spectrum (190-1100 nm) that includes not only the UV range, but also the visible and infrared, so that by using this method the wavelengths emitted by each pulse of light different from the range of UV could specifically affect the functional properties of the different tested samples. This does not occur with the continuous use of UV light, which is specific for the compounds absorbing the light in a range of 100-400 nm.

Moreover, the patent MX2007005728A describes the use of a red laser (0.7-100 μm) to irradiate fruits, achieving an increase of carotenoids in Solanum lycopersicum L. There are other documents that refer to the increase of flavonoids using other techniques, such as the patent ES2301234T3, which describes the manipulation of flavonoids in plants by expression of genes encoding transcription factors involved in controlling the expression of genes encoding enzymes of the biosynthetic pathway of flavonoids.

Another paths for achieving an increase of said compounds in fruits are the external application of compounds outside the flavonoid pathway using agrochemical compositions, as described in patent MX/a/2008/012253, the use of external agents that increase the polyphenol content of plants as described in patent ES2377082 and the application of lyophilized extracts of fermented or unfermented phenolic compounds of pomace from red grape Vitis vinifera at low temperatures applicable as an ingredient in foods and beverages suitable for human and animal consumption, as described in patent WO/2011/062468.

Moreover, the patent ES2717745 discloses a method for increasing the resveratrol content of grapes using UV pulses less than 5 seconds after storing the fruits for 3 to 4 days at room temperature. However, the condition of said method to store the fruits at room temperature for several days cannot be applied to many high perishable fruits such as berries, which require immediate refrigeration after harvest.

Consequently, it is necessary to provide simple and effective methods for increasing the nutraceutical content of fruits of commercial interest, for example strawberries, without affecting the nutritional properties of the product and allowing its preservation for longer periods, thereby improving its post-harvest quality.

### BRIEF DESCRIPTION OF THE INVENTION

The present invention provides methods for increasing the nutraceutical content in various fruits using physical post harvest treatments such as UV radiation and freezing in different forms, applicable, for example, to strawberries. According to the present invention, strawberries in different stages of ripening were collected and subjected to UV radiation at a dose of 2.0 kJ/m², resulting in a significant increase in the concentration of phenolic compounds and their antioxidant activity, where a subsequent freezing at 0° C. and −20° C. did not significantly alter the antioxidant capacity of the fruit. The highest concentration of phenols was obtained during irradiation of the inner and outer parts of the fruit cut in half and immediately after completion of the radiation treatment. The concentration of fisetin, quercetin, and pelargonidin in fruits treated by the method of the invention increased during the first two days of storage, where pelargonidin showed the highest treatment response increasing its concentration at least 50% on average.

### OBJECTIVES OF THE INVENTION

An objective of the present invention is to provide simple and effective methods for increasing the concentration of nutraceuticals in perishable fruits; for example, in the concentration of flavonoids, also increasing their shelf life by stimulating the fruits with different doses of UV light and stored at different freezing temperatures.

Another objective of the invention is to determine the content of flavonoids, anthocyanins, phenolic compounds, and antioxidant capacity of different presentations of perishable fruits, e.g. strawberries, stimulated with UV light and low temperatures.

Another objective of the invention is to evaluate the individual response of flavonoids such as fisetin, quercetin, and pelargonidin in perishable fruits, e.g. strawberry, exposed to different doses of UV light and stored at different freezing temperatures.

### BRIEF DESCRIPTION OF THE DRAWINGS

FIG. 1. Shows calibration curves of the compounds tested: a) Flavonoids measured as quercetin; b) Fisetin; c) Anthocyanins measured as pelargonidin; d) Quercetin; e) Phenolic compounds measured as gallic acid; f) Pelargonidin, g) Antioxidant capacity measured as mM trolox equivalent (ET); and h) Ascorbic acid. By spectrophotometry a), c), e), g) and h). By HPLC b), d) and f).

FIG. 2. Shows the concentration of compounds of three strawberry varieties: a) Flavonoids measured as quercetin; b) Anthocyanins measured as pelargonidin; c) Antioxidant capacity measured as mM trolox equivalent (ET). Different letters on each of the parameters show significant differences among varieties (ANOVA-Tukey) p<=0.05, n=3.

FIG. 3. Shows the concentration of compounds in strawberry fruits of the variety “Camino Real” stored at 0° C. and −20° C. a) Flavonoids measured as quercetin; b) Anthocyanins measured as pelargonidin; c) Antioxidant capacity measured as mM trolox equivalent (ET). Different letters on each of the parameters show significant differences among varieties (ANOVA-Tukey) p<=0.05, n=3.

FIG. 4. Shows HPLC chromatograms and wavelength scans of the standards used for quantification of flavonoids. The different compounds showed the following retention times in HPLC: a) Fisetin with a retention time of 39.177 min and quercetin with a retention time of 46.481 min; b) pelargonidin with a retention time of 21.373 min. The wavelength scan of each compound indicates the specific spectra of each: c) Fisetin spectrum; d) Quercetin spectrum; 4) Pelargonidin spectrum.

FIG. 5. Shows HPLC chromatograms of extracts of phenolic compounds from fruits of the strawberry variety “Camino Real”: a) Identification of fisetin (38.976 min) and quercetin (46.381 min) flavonols; b) Identification of anthocyanin pelargonidin (21.301 min).

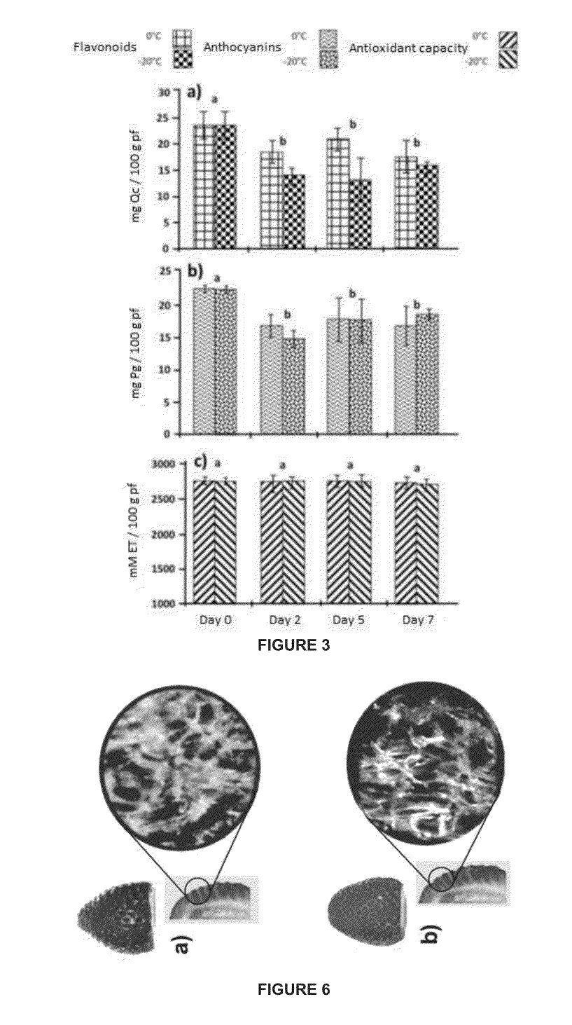

FIG. 6. Shows the difference between the tissue of fresh fruit and the tissue of irradiated fruit of the strawberry variety “Camino Real”: a) Whole fruit and microscopic cross-sectional view of the epidermal layer of the fresh fruit; b) Whole irradiated fruit and microscopical cross-sectional view of the epidermal layer of irradiated fruit.

FIG. 7. Shows the quantification of phenolic compounds at different doses of UV radiation measured in kJ/m²: a) Concentration of flavonoids; b) Concentration of anthocyanins; c) Concentration of phenolic compounds; d) Concentration of Antioxidant capacity; e) Concentration of fisetin; f) Concentration of quercetin; and g) Concentration of pelargonidin. Different letters indicate the statistical difference per parameter. (ANOVA-Tukey) p<=0.05, n=3.

FIG. 8. Shows the fruits collected at different days of petal fall (dpcp) at different stages of ripening of strawberry fruit.

FIG. 9. Shows the concentration of compounds at different development stages of the strawberry fruit in control samples and samples treated with UV-C light: a) Concentration of flavonoids; b) Concentration of anthocyanins; c) Concentration of phenolic compounds; d) Concentration of antioxidant capacity; e) Concentration of fisetin; and f) Concentration of quercetin. Different letters denote a significant difference between stages (ANOVA-Tukey) p<=0.05, n=3. *Denotes a significant difference p<=0.05, **p<=0.01 and ***p<=0.001, for irradiation treatment. Pelargonidin metabolite was not quantified, because anthocyanins were detected only in the final stages of fruit development.

FIG. 10. Shows irradiation of strawberry fruits with UV-C light (254 nm).

FIG. 11. Shows the percentage increase in each of the measured parameters of display of the sample irradiated with UV light as whole fruit, half fruit, and strawberry puree: a) Percentage increase of flavonoids; b) Percentage increase of anthocyanins; c) Percentage increase of phenolic compounds; and d) Percentage increase of antioxidant capacity. The values are an average of the data obtained in the samples of 0° C. and −20° C. per day. “Days of storage” without bar means p>=0.05.

FIG. 12. Shows the individual concentration of flavonoids in control samples and irradiated samples, stored for 9 days at 0° C. and −20° C. according to the method of the present invention: a) Percentage increase of fisetin; b) Percentage increase of quercetin; and c) Percentage increase of pelargonidin. Different letters denote a significant difference between stages (ANOVA-Tukey) p<=0.05, n=3. *Denotes significant difference p<=0.05, **p<=0.01 and ***p<=0.001 by irradiation treatment.

FIG. 13. Shows the determination of ascorbic acid in different presentations of strawberry fruit in control samples and samples treated by the method of the present invention. Different letters denote a significant difference per presentation of the fruit. (ANOVA-Tukey) p<=0.05, n=2.

### DETAILED DESCRIPTION OF THE INVENTION

The present invention provides simple and effective methods to substantially increase the nutraceutical content and antioxidant capacity in perishable fruits by treatment with ultraviolet light (UV-C) and subsequent storage at freezing temperatures in different fruit presentations. The methods of the invention allow increasing the concentration of flavonoids in treated fruits; e.g., phenols and anthocyanins, and the antioxidant capacity of the products. The present invention is a post-harvest treatment of perishable fruits using physical treatments such as ultraviolet radiation and freezing on different fruit presentations, which allow to obtain positive increase results in nutraceuticals; for example, phenols and anthocyanins typical of the fruit, even in fruits as delicate as strawberry (Fragaria x ananassa).

By the present invention, it is possible to achieve a significant increase in flavonoids, phenolic compounds, anthocyanins and antioxidant capacity using UV-C light and ideal freezing temperatures for storing the fruit. Furthermore, the present invention eliminates the application of known laborious and controversial methods to achieve the same purposes such as genetic modification and the addition of external chemical agents, which are harmful to the fruits.

Until the present invention, no method in the prior art considered the application of UV-C radiation in combination with storage at temperatures below 0° C. to different presentations of perishable fruits, such as strawberry, to substantially increase their nutraceutical concentration and shelf life. In Mexico and all over the world, strawberries are marketed as frozen product but, because of their high rate of respiration and susceptibility to fungal growth, their shelf life is very short. Hence, the method of the present invention represents a substantial technological advance, having a substantially better effect on the preservation of frozen strawberries in comparison with traditional methods of storage at freezing temperatures to maintain the nutritional quality of the product.

For purposes of the invention, the method for increasing the nutraceutical content of perishable fruits comprises the use of UV radiation with a light intensity of 0.5 to 4.0 kJ/m² and for 7 to 56 min intervals to subsequently subject the product to freezing temperatures of 0° C. or −20° C. during a period of up to 9 days, thereby increasing the content of flavonoids at least 29%, the content of anthocyanins at least 74%, the content of phenolic compounds at least 15%, and the antioxidant capacity at least 5%, wherein the content of anthocyanins and flavonoids augments in line with increasing freezing time of the fruit.

According to the method of the present invention, it is possible to increase the content of fisetin in at least 51%, quercetin in at least 31%, and pelargonidin in at least 72%, maintaining stable such increases in the frozen fruit during its storage through the above freezing temperature.

Also, the method of the present invention can be applied to different presentations of perishable fruit typical for commercialization, such as whole fruit, fruit in half, and fruit puree and is applicable to fresh produce such as raspberries, blueberries, strawberries, blackberries, juneberries, red currants, wild berries or capuli and grapes, and any other fruit containing flavonoids, phenols, and/or anthocyanins.

Phenolic compounds are one of the major types of metabolites present in the plant kingdom, where they perform various physiological functions. Among others, they are involved in the growth and reproduction of plants and in defensive processes against certain biological and physical agents such as pathogens, predators, or UV radiation. Quantities and types vary depending on the plant species, variety, part of the plant considered, hours of sun exposure, maturity, growing conditions, processing, storage, etc. Chemically, phenolic compounds all have one benzene ring hydroxylate as common element of their molecular structures, which can include functional groups such as esters, methyl esters, glycosides, etc. They can be conjugated to sugars such as glucose, galactose, arabinose, rhamnose, xylose, and glucuronic or galacturonic acid. They can also bind to carboxylic acids, organic acids, amines, and lipids.

The methods for detection, isolation, and identification of phenolic compounds are based on their acidic properties and polarity. Most phenols are solid and their color changes from colorless to strong color, depending on the structure conjugation. Their solubility in polar solvents (methanol, ethyl acetate) allows differentiating them from other liposoluble and colorful pigments like carotenoids. Owed to their aromatic nature, they show strong absorption in the UV region of the spectrum, a popular spectral method for quantitative analysis.

The antioxidant activity of phenolic compounds is attributed to their ability to transfer hydrogen atoms or electrons from an aromatic hydroxyl group into a free radical generating a more stable phenoxyl radical, or alternatively to chelate metal ions such as iron and copper, which catalyze the reactions of formation of free radicals liberated from oxygen.

Flavonoids are found both in free state and polymerized and are the most diversified and widely distributed group of phenolic compounds in plants. There are 13 subclasses of known flavonoids with a total of more than 5,000 compounds. Their basic structure is represented by a hydrocarbon skeleton arranged under a C6-C3-C6 system called dyphenylpyraline, which consists of two benzene rings linked by a chain of 3 carbon atoms derived from shikimic acid. Heterosides of flavonoids sugar linkages occur predominantly in the position 3 of the C ring by a β-glycosidic bond. Flavonoids are widely distributed in fruits and vegetables, located mainly in the superficial tissues of aerial organs such as leaves and flower buds, but are also present in chloroplasts and membranes, and dissolved in the vacuolar content. Black tea, coffee, beer, red wine, fruits and vegetables constitute a rich dietary source of flavonoids. These compounds play a key role in the physiological and biochemical activities of plants by developing the following functions: they act as solar filters absorbing UV radiation, which protects vegetal tissues of harmful radiation; they are involved in reproductive processes, favoring the attraction of pollinating insects through their varied colors and presence in the tissues of flowers; and the inhibitory capacity of certain plant hormones showed by some flavonoids suggests their action as plant growth regulators. The effectiveness in capturing free radicals varies depends on the type of flavonoid. Following structural characteristics determine the antioxidant capacity of each of them: the presence of the catechol group, two hydroxyl groups in position 3′ and 4′ in ring B; the presence of two hydroxyl groups in position 5, in ring A; and the presence in ring C of the double bond between carbons 2 and 3 along with 4-keto groups. These structures are important for electron delocalization and phenoxyl radical stabilization, provided that both hydroxyls are present in ring B. Aside from the structural characteristics mentioned above, there are other factors affecting the antioxidant capacity of phenolic compounds. Thus, the polymerization degree or the presence of sugar moieties and the number and position of the hydroxyl group will determine some proprieties of the phenolic compounds such as solubility and tendency to transfer electrons and hydrogen atoms. Phenolic compounds with a high number of hydroxyl groups in their molecular structures show a greater antioxidant activity in vitro, and polymeric compounds are more potent as antioxidants than monomers. Additionally to their anti-cancer activities, flavonoids have been proven to have anti-inflammatory, antiviral and anti-allergenic properties and also acting as protective agents against neurodegenerative and cardiovascular diseases such as infarcts, atherosclerosis, and hypertension among others.

Depending on the degrees of oxidation and introduction of the heterocyclic ring (ring C), it is possible to differentiate various classes of flavonoids, and within each class distinctions can be made based on the nature and number of the substituents attached to rings A and B. In this review, flavonol families and anthocyanins play a key role, where anthocyanin compounds show special characteristics owed to their low stability during the processing and storage of fresh produce.

Anthocyanins are glycosides of anthocyanidins and belong to the family of flavonoids, having the same biosynthetic origin and the characteristic C6-C3-C6 skeleton. They constitute the largest group of water-soluble pigments detectable by human visual perception and represent a wide range of colors from red to blue, producing the color of many fruits, vegetables, and grains. At present, there is a considerable demand for natural dyes, which has increased the need to successfully extract them from natural sources such as purple corn, cabbage, purple sweet potato, radish, and berries such as strawberries, whose anthocyanin concentration is in average 26-60 mg/100 g fresh fruit.

Factors that influence the stability of anthocyanins are pH, temperature, solvent, oxygen presence, and interaction with other food components such as ascorbic acid, metal ions, sugars, and co-pigments.

Anthocyanidins are less stable than anthocyanins and less soluble in water; therefore, it is assumed that glycosylation provides stability and solubility to the pigment. A higher degree of hydroxylation generally decreases the stability of anthocyanin, while an increase in the methoxylation or glycosylation degree has the opposite effect. For example, diglycosides are more stable than monoglycosides to discoloration during storage, heat treatment, and light exposition. The sugar nature influences the stability; e.g., anthocyanin, which contains galactose, is more stable than that contains arabinose. Anthocyanins are unstable in the presence of oxygen, thermolabile, and changes in pH cause their structural transformation. In the presence of oxygen, the maximum thermal stability of anthocyanidin-3-glycosylated is within a range of pH 1.8 to 2.0, while for 3.5-diglycosides the range is of pH 4.0-5.0. At a pH between 2 and 4, the main degradation pathway is the hydrolysis of the carbohydrate molecule.

Anthocyanins are generally unstable when exposed to visible light, some being more affected than others; for example, anthocyanins with the hydroxyl group at C-5 are more susceptible to decomposition than those that are not substituted in that position. The presence of ascorbic acid causes discoloration of anthocyanins, presumably by indirect oxidation by hydrogen peroxide formed during the aerobic oxidation of ascorbic acid. The high sugar concentrations (greater than 20%) or syrup used to preserve fruits tends to exert a protective effect on anthocyanin. The intermolecular co-pigmentation of anthocyanins that is, the formation of protein complexes, tannins, and other flavonoids such as quercetin and rutin, increase the stability and color of anthocyanins. Enzymes having the β-glucosidase character hydrolyze the glucoside bond at C-3 to afford the corresponding aglycone, which is colorless. The presence of monovalent ions, such as sodium and potassium, or divalent such as calcium and magnesium, causes anthocyanins to change their color. Anthocyanins are sensible to pH variations. In acid conditions such as pH 3, the pigment is present as red colored flavylium salts; in alkaline conditions such as pH 8, they are violet colored, and at pH 11, blue colored.

An embodiment of the present invention is to provide methods used to determine the antioxidant capacity of the fruits based on the reduction of a radical (2,2-diphenol-1-picrilhidrazil or DPPH) by the donation of hydrogen atoms of the antioxidant present in the sample, wherein the compound 6-hydroxy-2,5,7,8-tetramethylchroman-2-carboxylic acid or Trolox is used.

Another embodiment of the present invention is the quantification of the content of flavonoids anthocyanins and the antioxidant capacity of fruits, for example, strawberry fruits. In still another embodiment of the present invention, it is possible to determine the behavior of three of the main flavonoids found in the strawberry fruit, two of them flavonols (quercetin and fisetin) and anthocyanin, pelargonidin, in relation to the method of the present invention.

Fleshy fruits are highly perishable products after they have been harvested. Many are the causes that produce losses in the post-harvest period of fruits, including pre-harvest factors, varieties, inadequate collection and handling techniques, storage with incompatible products, increase of ethylene during storage, senescence, infections caused by bacteria and fungi, etc. Historically, the attempt has been made to remediate these losses, particularly those caused by pathogens, by using synthetic chemicals, such as insecticides and fungicides. These methods are most popular among producers mainly because of their relatively low cost and easy application. Despite these advantages, it is known that the chemical compounds used cause many adverse effects on human health, as they are potential carcinogen and toxic agents, aside from being potential contaminants of the environment. Also, overuse generates waste accumulation and promotes the development of resistant strains. As an option for eliminating these treatments with chemical agents, appeared a wide variety of technologies, which are healthy for consumers and environmentally friendly and are known as “physical treatments.”

The physical treatments used to prolong the shelf life of fruits and vegetables include refrigeration, ozone applications, modified and controlled atmospheres, high-temperature thermal treatments, freezing and UV light irradiation.

Freezing is a widely used technology for the storage and transport of plant products, whose action consists of making solid the water contained in them. The use of this method allows retarding the loss of quality of perishable food by stopping its biological activity. The freezing process does not markedly alter the aroma of fresh fruit, except if the operation lasts a very long time. During storage, fruit must be maintained within a narrow range of ±1° C. of the desired storage temperature; below this optimum range, some products, especially those from tropical climates, may suffer cold damage. Above this range, the product shelf life is shortened.

Freezing can be done by rapid or slow methods. In slow freezing, which is the method used in the present invention, the product is subjected at low temperatures and allowed to freeze. The temperature range is of 1° C. to −20° C.; the freezing time depends on the volume of the product and the freezing conditions, as air circulation generally occurs through natural convection. The conservative effect is obtained by inhibiting undesirable reactions and maintaining the product in this state during storage, whereby the physical, chemical, and microbiological changes are reduced as much as possible by exactly determining the treatments prior to freezing, optimal rate of freezing, type of packaging, storage temperature and rate of thawing.

UV light treatments consist of exposing horticultural products for a certain time under a bank of UV lamps. Although at high doses UV light is harmful for live beings, at low doses it produces various beneficial effects inducing disease resistance, delayed ripening, and improves the attributes of the fruit providing a higher quality to the products. This biological phenomenon is called “hormesis” and refers to the use of an agent that is normally harmful to living things, but at low doses produces a beneficial effect. UV radiation has greater energy than visible light and is considered non-ionizing, whose action seems to affect only those compounds that absorb it directly. UV-type photons, which are more energetic than the visible type, can promote electronic transition, thus inducing chemical changes that directly affect the development of chemical bonds, or altering the structure of molecules possessing them. In a cell, the direct absorption of UV rays is mainly confined to organic compounds with ring structures, such as phenolic compounds. This type of radiation occupies the range of wavelengths from X-rays and visible light, and can be subdivided into three regions: UV-C (100-280 nm), UV-B (280-300 nm) and UV-A (320 to 400 nm).

Importantly, UV treatments have several advantages for use in post-harvest including practicality, as they are simple, clean, and low-cost procedures performed at low temperatures without moisturizing the product, require less space than other methods and demand low maintenance. These features, plus the fact that they can be easily incorporated into a processing line, their implementation requires a low investment, and there are, in general, no legal restrictions to their application, make them an attractive option as a post harvest treatment.

The following examples are included with the sole purpose of illustrating the present invention and without implying any limitation on its scope.

### EXAMPLE 1

Preparation of the samples. Strawberry whole fruits, half fruits and puree were placed in plastic trays (17×25 cm), which were introduced into a black box (55×55 cm) containing fluorescent UV lights (TecnoLite 615T8) horizontally arranged in the upper part of the box at a distance of 10 cm from the fruits. The emitted light intensity was 1.2 KJ/m² determined by a radiometer (LI-COR, LI-189). After protecting the radiation area with black plastic bags, the fruits were irradiated for different periods of time. Whole fruits were placed laterally and turned twice during the radiation time to irradiate the larger area. Strawberry halves were sliced from the pedicel to the tip, exposing both the internal and external areas to the UV light. Samples were taken according to the test.

### EXAMPLE 2

Extraction of phenolic and polyphenolic compounds. Phenolic compounds were extracted from 10 g of the homogenates of the fruits with and without treatment. They were placed in mortars and ground with liquid nitrogen to obtain very small and homogeneous particles. A portion of the ground sample (1 g) was placed in a glass beaker and added the extraction solvent: methanol (Karal) acidified at 0.05% with trifluoracetic acid (Sigma-Aldrich) and water: acetone (Karal) (40:60 v/v) acidified with 0.05% trifluoracetic acid (30:70 v/v). The following ratio was used for solvent addition: 50 mg ground sample/1 mL solvent. It was mixed on a shaker (New Brunswich Scientific) for 2 hours at room temperature. At the end of the mixing time, it was centrifuged (Refrigerated Superspeed Centrifuge, Sorvall RC-5B, using a Sorvall SS-34 rotor) for 10 minutes at 9,500 rpm and at 5° C. The supernatant was concentrated in a rotary evaporator (BUCHI 461) for 15 minutes at 37° C. until obtaining approximately 4.5 mL of the extract; the remaining supernatant was concentrated with industrial grade nitrogen at 37° C. to recover 1 mL of extract. The entire procedure was performed covering the material with aluminum foil to prevent photo-oxidation of the compounds (Mane et al., 2007, with modifications).

### EXAMPLE 3

Hydrolysis of phenolic and polyphenolic compounds. Hydrolysis was performed based on the methodology of acid hydrolysis by Giusti and Wrolstad described in 1996 with modifications. The double of volume (2 mL) of HCl (Karal) 2 N was added to the mL obtained from the extraction of compounds and allowed to boil for one hour. At the end of the time, the samples were transferred to ice for 15 minutes. They were centrifuged for 20 minutes at 12,000 rpm and at 5° C. (MicrofugeR 18 Centrifuge by Beckman Coulter). The supernatant was recovered, and the compounds were extracted with 1 mL of ethyl acetate (Karal) four times. The 4 extractions were collected and the excess of solvent was removed in the rotary evaporator to obtain 0.5 mL of final extract, which was diluted in 2 mL of pure methanol (Karal) (Espinosa-Alonso et al., 2006, with modifications). From this diluted extract the total of flavonoids, anthocyanins, phenols, antioxidant capacity, and individual content of fisetin, quercetin and pelargonidin was quantified. The entire procedure was performed rapidly and under reduced light.

### EXAMPLE 4

Analytical determination of flavonoids. For general quantification of flavonoids, we used a Multiskan EX spectrophotometer (Thermo Scientific) and 96-well plates of polystyrene (Microtest, FALCON). In addition, a UV-VIS spectrophotometer (Shimadzu) and disposable semi-micro cuvettes of 1.5 mL capacity (12.5×12.5×45 mm, Plastibrand) were used to quantify the general content of anthocyanins, phenols, and antioxidant capacity. Ascorbic acid quantification was performed using optical glass cuvettes of 3 mL capacity (45×12.5×12.5 mm, Hinotek).

a) Determination of total flavonoid content. Quantification was performed by aluminum chloride colorimetric method, modified from the procedure reported by Woisky and Salatino in 1998. Different concentrations of quercetin (Sigma-Aldrich) from a stock of 1 mg/mL dissolved in pure methanol were used as standard. 500 μL of standard solution or the corresponding samples in triplicate were taken, adding 460 μL of pure methanol, 20 μL of aluminum chloride at 10% (J. T. Baker) and 20 μL of potassium acetate at 7.5% (J. T. Baker); the mixture was vortexed for 15 seconds and allowed to incubate for 45 minutes in the dark at room temperature. The absorbance was read at a wavelength of 450 nm using 200 μL of the initial mixture. Distilled water was used as blank in substitution for the solution of quercetin and aluminum chloride. The total flavonoids were expressed as mg quercetin/100 g fresh weight.

b) Determination of total anthocyanin content. Determination was based on the method of pH differential described by Cheng and Breen in 1991, and different pelargonidin concentrations (Sigma-Aldrich) were used as standard from a stock solution of 1 mg/mL diluted in pure methanol. 300 μL of the standard solution or the corresponding samples in triplicate were taken, adding 700 μL of buffer 1:2.5 mM of potassium chloride (KEM) at pH 1.0, vortexed for 10 seconds; and the absorbance was read at 510 and 700 nm. Subsequently, solutions were prepared using 300 μL of the standard or the samples analyzed and 700 μL of buffer 2: 400 mM potassium acetate (J. T. Baker) at pH 4.5; the solutions were vortexed for 10 seconds and their absorbance was read at 510 and 700 nm. Methanol was used as blank in substitution for the samples of interest. The total absorbency was determined using the following formula:

Absorbance=(A510−A700) pH1.0−(A510−A700) pH4.5 (1)

The total of anthocyanins was expressed as mg pelargonidin/100 g fresh weight.

c) Determination of total phenolic compounds content. Total phenolic content was determined using Folin-Ciocalteau reactive by the method of Slinkard and Singleton described in 1997 and with different concentrations of gallic acid (Sigma-Aldrich) from a stock solution of 1 mg/mL diluted with pure methanol. 100 μL of standard solution and the extracts of the corresponding samples in triplicate were taken and added 500 μL of Folin-Ciocalteau 1 N reactive; the combination was mixed for 5 minutes in shaker (Roto Mix Thermolyne) and added 400 μL of sodium carbonate at 7.5% (p/v) (KEM), vortexed for 10 seconds and allowed to incubate for 90 minutes in the dark at room temperature. Its absorbance was read at a wavelength of 765 nm. Distilled water was used as blank in substitution for Folin-Ciocalteau reactive and methanol to replace the standard solution. The total phenolic compounds were expressed as mg gallic acid/100 g fresh weight.

d) Determination of the antioxidant capacity. DPPH method (2,2-diphenyl-1-picrylhydrazyl) was used and performed based on the report by Brand-Williams et al., (1995), using as antioxidant compound 6-hydroxy-2,5,7,8-tetramethylchroman-2-carboxylic acid or Trolox (Sigma-Aldrich). A solution of 3.9 mg DPPH (Sigma-Aldrich) was prepared in 100 mL of methanol at 80% in distilled water. 900 μL of this solution was mixed with 100 μL of different Trolox solutions, or with extracts from the corresponding samples in triplicate. A reference target was prepared with 900 μL of DPPH and 100 μL of solvent (methanol at 80%). It was incubated at room temperature during 120 minutes in the dark, and its absorbance was measured at 517 nm in the UV-VIS spectrophotometer. The total absorbency was determined as follows:

Absorbency=Blank absorbency−Sample absorbency (2)

The total antioxidant capacity was expressed as mM Trolox Equivalent or ET/100 g fresh weight.

### EXAMPLE 5

Analysis of flavonoids on high performance liquid chromatography (HPLC). Rapid resolution liquid chromatograph (Agilent Technologies 1200 Series) was used coupled with a diode array detector (DAD) (Agilent Technologies).

a) Determination of fisetin and quercetin. The fisetin and quercetin metabolites were detected from the extract of phenolic compounds using a reversed-phase YMC-Pack ODS C18 column (Phenomenex) (5 μm particle diameter, 250 mm long and 4.6 mm internal diameter). A gradient run was performed under following conditions: Solvent A acetic acid HPLC grade pH 3 and solvent B acetronile HPLC grade; at time zero, 0% B; at 5 min 10% B; at 12 min 12% B; at 36 min 23% B; at 48 min 35% B; and at 60 min 100% B. Final injection volume was 100 μL, with a flow of 1 mL/min and a temperature of 28° C.; detection was done at 360 nm. The quantification of the compounds was performed interpolating the readings on the standard curve. The mobile phase was previously degassed in a sonicator (Branson 2510) and filtered through a 0.1 μm nylon membrane resistant to solvents (MiliporeMR, Durapore) (Fang et al., 2007, with modifications).

b) Determination of pelargonidin. The pelargonidin pigment was identified from the extracts of phenolic compounds using a VYDAC 2015P54 C18 reversed-phase column (250 mm long) (GRACE). The pelargonidin concentration was determined by injecting samples and pattern standard solution of pelargonidin to relate the peak areas and retention times. A gradient run was done using as solvent A: water acidified with acetic acid pH 2.3; and solvent B: water:acetic acid pH 2.3:acetonitrile (214:80:100); at zero time 20% B; and at 45 min 70% B. The managed flow rate was 1 mL/min, the injection volume was 100 μL and the wavelength was 510 nm. The mobile phase was previously degassed and filtered with a 0.1 μm nylon membrane (Fazeelat et al., 2007, with modifications).

### EXAMPLE 6

Statistical analysis. The concentration data of phenolic compounds at different temperatures and storage days, and during the various stages of development were analyzed using ANOVA (analysis of variance) for multifactorial design and multiple comparison test of Tukey. The t-Student test was used to compare the compound concentrations between control and irradiated samples. For statistical computing, we used R-project 2.12.2 open source software in all cases.

The biological material used in the present invention consisted of strawberry fruits cv. “Camino Real,” “Festival,” and “Albion”' at different ripening stages. However, any fruit or vegetable can be used with the method of the invention. Strawberries were acquired from the fields in the cities of Zamora, Michoacán and Irapuato, Guanajuato, Mexico.

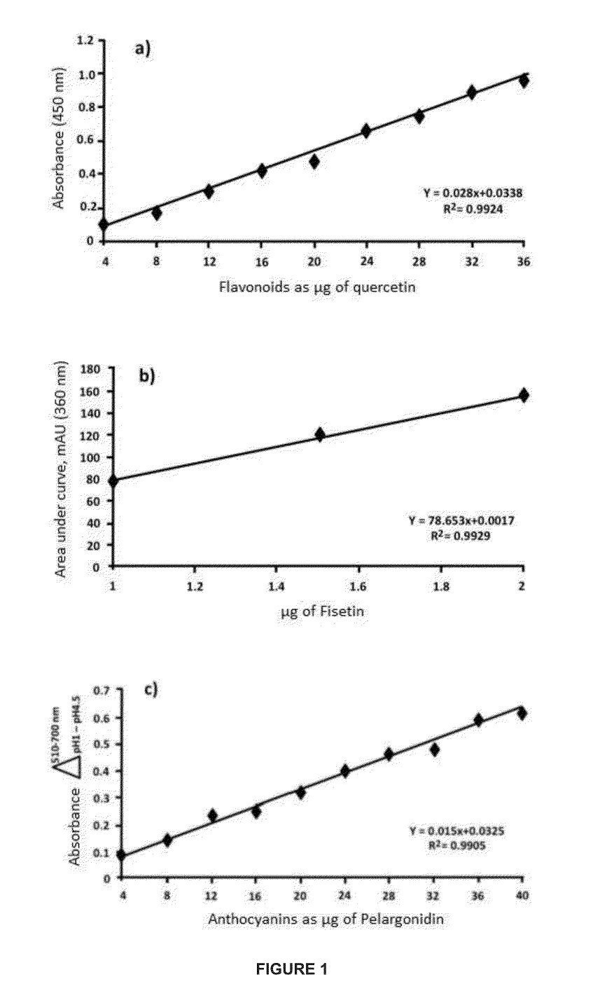

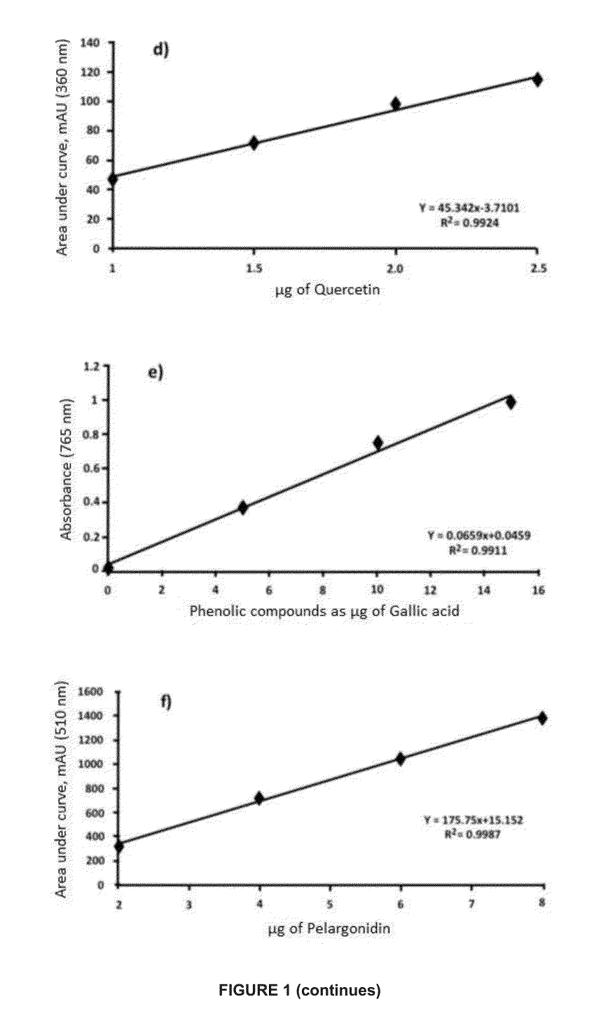

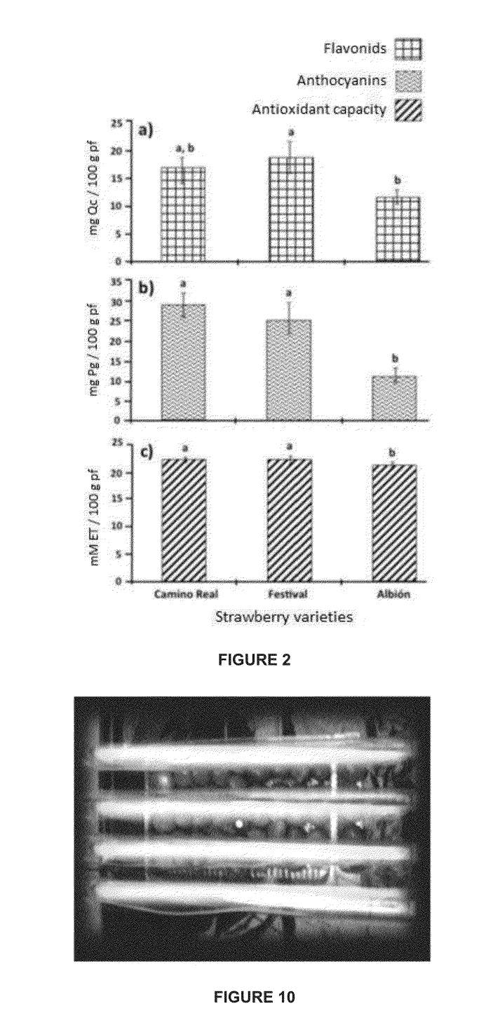

Strawberry (Fragaria x ananassa) was used as raw material. For determining total flavonoids, anthocyanins, phenolic compounds, and antioxidant capacity of the different samples, we performed calibration curves (FIGS. 1a, 1c,1e, 1g) to calculate the concentration of these compounds in different strawberry varieties. The identification and quantification of specific metabolites, for example, fisetin, quercetin, and pelagornidin, was performed using HPLC technique (FIGS. 1b, 1d, 1f, 1h, 4a, 4b, 4c, 4d, 4e). The varieties “Camino Real,” “Festival,” and “Albion” planted and harvested in the states of Guanajuato and Michoacán had a similar weight and size (approximately 13.5 g and 3.5 cm long×3.2 cm wide), and the “Albion” with a slightly larger range. No significant differences were found in the pH of the varieties. However, the distinction in the total solid soluble content was very evident, showing the “Albion” cultivar a higher °Brix (9.25±0.07) (table 1). Nevertheless, this variety showed a lower content of total anthocyanins and less antioxidant capacity than the rest of the fruits analyzed (FIGS. 2b, 2c). Moreover, the varieties “Camino Real” and “Festival” showed similar total concentrations of flavonoids (17.29 mg Qc/100 g pf), anthocyanins (27.04 mg Pg/100 g pf), and antioxidant capacity (1902.76 nm ET/100 g pf) (FIGS. 2a, 2b, 2c).

TABLE 1
Comparison of some physiochemical characteristics
of the varieties of strawberries studied

| Parameter | Variety | | |
|---|---|---|---|
| determined | ‘Camino Real’ | ‘Festival’ | ‘Albión’ |
| Weight (g) | 13.14 ± 2.25 a | 12.92 ± 1.29 a | 14.53 ± 2.71 a |
| Length (cm) | 3.32 ± 0.35 a | 3.33 ± 0.34 a | 3.87 ± 0.46 b |
| Width (cm) | 3.28 ± 0.45 a | 3.18 ± 0.31 a | 3.34 ± 0.40 a |
| Ph | 3.32 ± 0.14 a | 3.29 ± 0.02 a | 3.34 ± 0.03 a |
| ° Brix | 6.8 ± 0.14 a | 8.5 ± 0.14 b | 9.25 ± 0.07 c |

Different letters on each of the selected parameters express significant differences among the varieties (ANOVA-Turkey) p <= 0.05, n = 10.

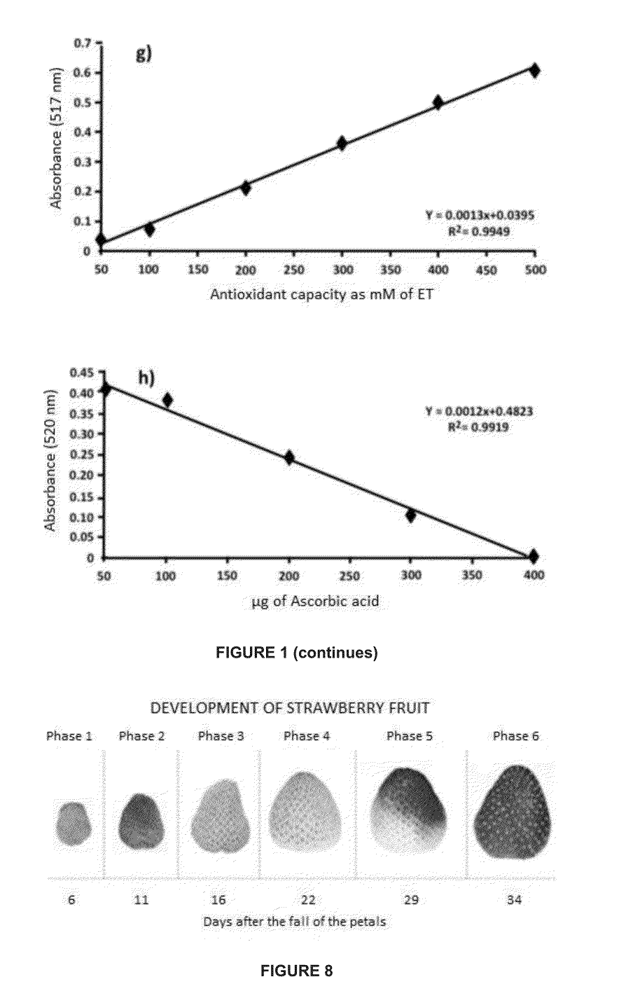

Whole fruits of the “Camino Real” cultivar were stored for 7 days at 0° C. and −20° C., and it was observed that the diverse storage temperatures did not represent significant differences in the concentrations of flavonoids and anthocyanins of the fruit. However, freezing itself caused variations in both parameters, being more evident among the concentrations of the samples corresponding to day zero and day two, wherein an approximate decrease of 32% in flavonoids and 30% in anthocyanins was observed (FIGS. 3a, 3b). The values obtained in the other samples remained constant in both cases.

This led us to the conclusion that fresh strawberry fruits have highest concentrations of flavonoids and anthocyanins than fruits frozen at 0° C. and −20° C. Furthermore, the antioxidant capacity of the same samples stored at said temperatures was not altered by any of these two factors: temperature and storage (FIG. 3c). Thus, the decrease in the content of anthocyanins and flavonoids caused by low storage temperatures was not statistically significant to affect the antioxidant capacity of strawberry fruit.

According to our results, we observed that although freezing at 0° C. and −20° C. is one of the most popular post-harvest techniques used in the industry for storing and maintaining the quality of the fruit, this method causes the loss of polyphenolic compounds. Thus, the embodiment of the present invention using the method of UV-C radiation to maintain and/or increase the nutraceutical quality (concentration of antioxidant compounds) of different presentations of the fruits (e.g., whole fruit, half fruit, and puree) becomes relevant.

The labeling was performed on the strawberry plants in the final stages of petal drop using small pieces of red raffia. Sixty fruits of each ripening stage (6, 11, 16, 22, 29 and 34 days post petal drop) were collected and divided in two batches of 30 fruits each: one group was designated as control sample and the other group was subjected to irradiation treatment. The fruits were transported to the laboratory in plastic bags and immediately analyzed.

Once the strawberry fruits were selected, the corresponding sepals and pedicles were separated using a knife and washed with 10% liquid soap; water excess was retired with paper towels. The fruits were immediately weighed using a balance (Scout™ Pro, OHAUS), and their weight was determined using a caliper vernier (Foy Tools).

The fruits were chopped and liquefied in a tissue homogenizer (Waring Commercial Blender) for 1 minute at 23° C. Each sample consisted of 10 whole fruits. The puree obtained was placed in labeled and sealed plastic bags. The homogenate was used for performing physiochemical analysis and the extraction of phenolic compounds. These operations were performed for the three different presentations of strawberry used in the present invention, such as whole fruit, half fruit, and puree and at different days of storage. Total soluble solids of the homogenate were directly determined with a hand refractometer (Gebrauchsanweisung) previously calibrated with distilled water at 20° C. For the samples of the fruits from the different stages of ripening, °Brix determination was performed from the dilution of 10 g tissue of 10 fruits of each stage in 10 mL of distilled water. All the values were reported as °Brix. The pH of the samples was measured from blends obtained by using a potentiometer (Thermo Scientific) at 23° C., previously calibrated at pH 4.0 and 7.0 with buffer solutions. The different presentations of the samples with pre-treatment preparation were placed in sealed plastic bags (Impulse Sealer) and they were storage in a plastic tray and in separate rooms reaching freezing temperatures of 0° C.±1° C. and −20° C.±1° C. Sampling was performed on the different days of interest.

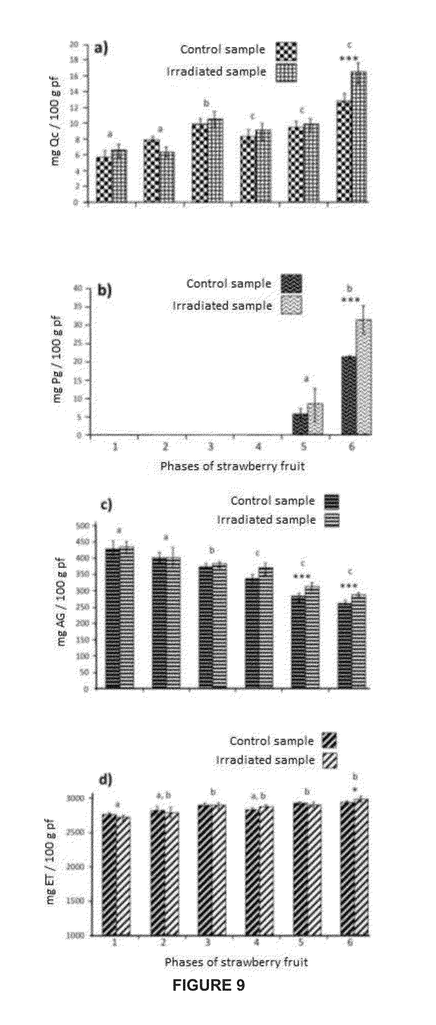

UV radiation of the different strawberries preparations mentioned above (whole fruit, half fruit, and puree) was performed by placing approximately 600-1000 g of the fruit in plastic trays (17×25 cm), which were introduced into a black box (55×55 cm) containing four fluorescent UV lamps (TecnoLite 615T8) arranged horizontally on the top of the box at a distance of 10 to 15 cm from the fruits (FIG. 10). The intensity of the emitted light was 1.2 W/m² determined by a radiometer (LI-COR, LI-189).

After protecting the radiation area with black plastic bags the fruits were irradiated at different times (7, 16.5, 28, 41.5, and 55.5 min). Whole fruits were placed laterally and turned twice during the exposition time to irradiate the larger area. Strawberry halves were sliced from the pedicel to the tip, exposing both the internal and external areas to the UV light.

To standardize the technique, some preliminary tests were performed; a total of 150 whole fruits of the variety “Camino Real” and samples were taken by triplicate (10 fruits per sample) at different times after irradiation. It was observed that all samples treated showed at 0 min of the stimulus a larger amount of compounds and antioxidant capacity compared to the control samples. The extracts corresponding to subsequent times showed a smaller increase in the compound concentrations; in some quantified parameters such as anthocyanins and antioxidant capacity, it was even observed that the concentrations were equal to those of the control samples after 30 minutes (table 2).

Accordingly, we can conclude that when strawberry fruits are affected by the stimulus of radiation they respond to the damage by synthesizing a higher content of these compounds as a defense, and when withdrawing the excess of light, the maximum concentration achieved tends to decrease over time. The radiation effect can be explained in two ways: 1) when the light strikes the epidermal cells of the fruit, it responds directly with an excessive synthesis of flavonoids to increase the number of light filters (biological function of flavonoids) and prevent photo oxidation of the compounds; or 2) the fruit can block the penetration of UV light inside the interior of the cells, reinforcing and restructuring the cell walls, which requires the synthesis of compounds known as proanthocyanidins, which are flavonoid polymers that bind to cell-wall polysaccharides. The conformation of these new compounds, causes a wasting condition of flavonoids, which could trigger a cascade of signals directed to activating certain genes encoding enzymes involved in the biosynthetic pathway of flavonoids, such as PAL (phenylalanine ammonia lyase) and CHS (chalcone synthase) and thus, the quantity of phenolic compounds would increase.

TABLE 2
Concentration of phenolic compounds in whole
fruit at different times after irradiation

| Time¹ | Flavonoids² | Anthocyanins³ | Phenols⁴ | Antioxidant capacity⁵ |
|---|---|---|---|---|
| Control | 19.16 ± 0.69 a | 19.63 ± 1.63 a | 185.45 ± 5.53 a | 2344.22 ± 48.95 a |
| 0 | 26.11 ± 0.02 b | 33.87 ± 0.70 b | 196.28 ± 4.23 b | 2617.30 ± 21.75 b |
| 15 | 26 ± 0.17 b | 28.48 ± 1.63 b, c | 189.37 ± 1.30 b | 2524.99 ± 32.63 b, c |
| 30 | 23.02 ± 0.65 c | 22 ± 2.41 a, c | 189.28 ± 4.23 c | 2559.61 ± 43.51 a, c |
| 60 | 24.56 ± 0.04 d | 20.02 ± 0.38 a | 189.83 ± 4.23 d | 2426.91 ± 29.91 a |
| 120 | 24.52 ± 0.09 d | 23.04 ± 3.26 a, c | 188.33 ± 5.05 d | 2455.76 ± 81.59 a, c |

¹min after radiation at 25° C.;
²mg Qc/100 g pf;
³mg Pg/100 g pf;
⁴mg AG/100 g pf;
⁵mM ET/100 g pf.
The means in the same row with different letters indicate statistically significant differences (ANOVA- Tukey) p <= 0.05, n = 3.

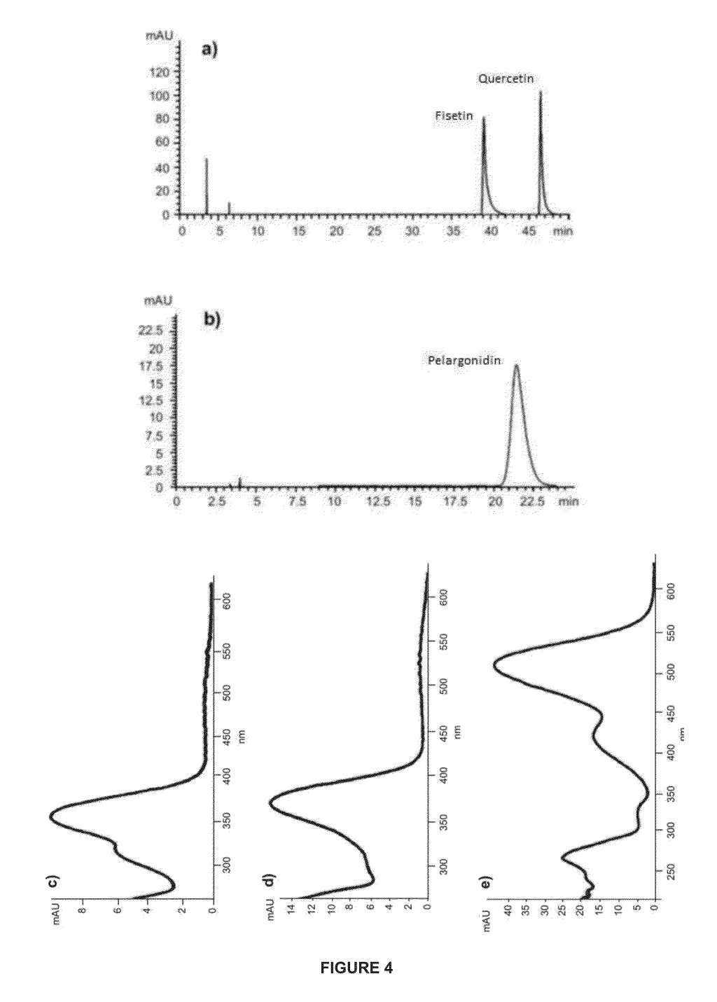

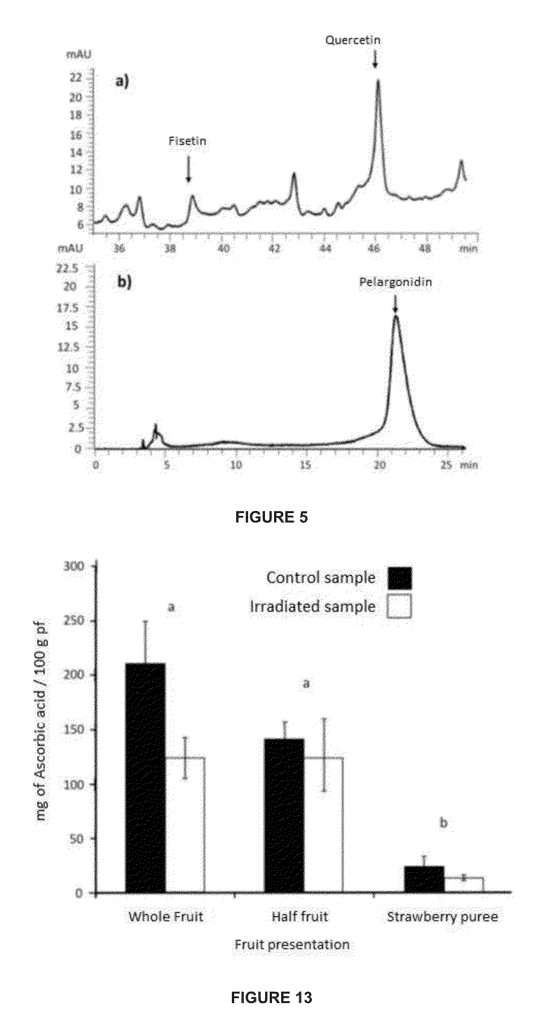

After observing that UV radiation caused no apparent effect on whole fruit to a macro and microscopic level (FIGS. 6a, 6b) and that the largest increase of phenolic compounds was obtained immediately after completing the radiation treatment, we proceeded to determine what dose of irradiation had better effect. Thus, 150 fruits were stimulated with different doses of UV light between 0.5-4.0 kJ/m² (table 3), and we found that for the four parameters quantified graphically (FIGS. 7a, 7b, 7c, 7d) the bar corresponding to a dose of 2.0 kJ/m² was statistically higher than the control sample. The samples subjected to higher doses (3 and 4 kJ/m²) showed similar concentrations than the control sample. Consequently, we concluded that an excess of UV light above 40 min causes photo inhibition of the treatment. The metabolites of particular interest such as fisetin, quercetin, and pelargonidin were quantified by HPLC in the different extracts of the samples irradiated at different doses. Such as in the total content of phenolic compounds, it was found that for the tree individual flavonoids (FIGS. 7e, 7f, 7g) the dose of 2.0 kJ/m² produced the highest increase.

TABLE 3
Irradiation time for different doses

| Irradiation dose | Irradiation time |
|---|---|
| 0.5 kJ/m² | 7.0 min |
| 1.2 kJ/m² | 16.5 min |
| 2.0 kJ/m² | 28.0 min |
| 3.0 kJ/m² | 41.5 min |
| 4.0 kJ/m² | 55.5 min |

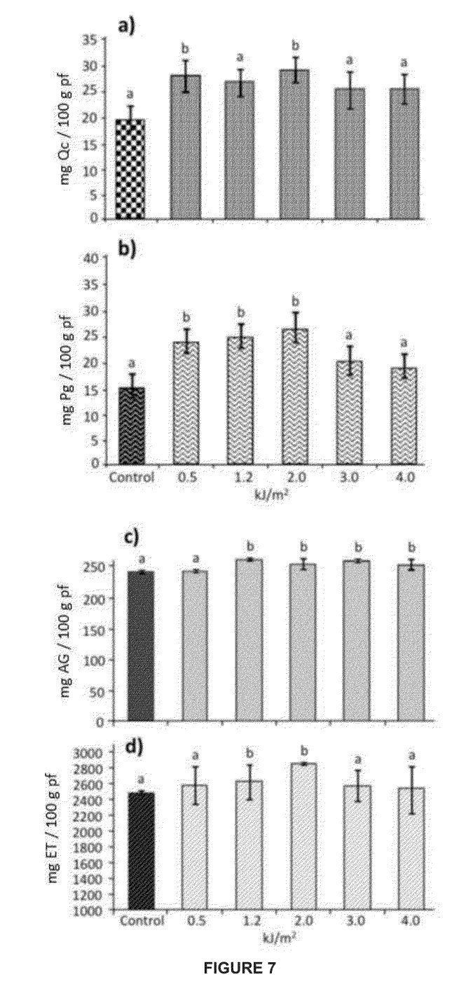

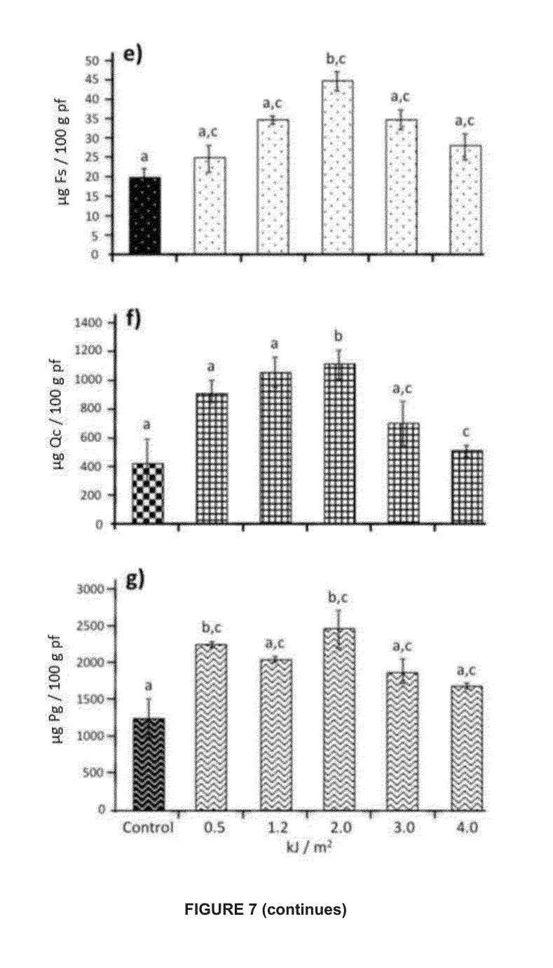

Furthermore, the analysis of fruits at different ripening stages (FIG. 8) showed the following: Flavonoids (FIG. 9a) are present in the different development stages of the fruit increasing gradually and reaching a maximum concentration at stage six (12.57 mg). Based on the above, we proceeded to determine if fisetin and quercetin (FIGS. 9e, 9f) showed the same behavior. The maximum concentration of both compounds was observed in stage 6 (FIG. 8f): 1031.57 μg for quercetin and 35.60 μg for fisetin for each 100 g of fresh weight. Quercetin was identified in the different times of development, whereas fisetin was located only in the final ripening stages. We conclude that, although both compounds differ in structure only by a hydroxyl group, they are likely to have particular functions in the physiology of the fruit during its development. As expected, anthocyanins (FIG. 9b) were only identified in the later stages, showing a significant increase in the fruit's ripening. The total concentration of phenolic compounds showed an inverse behavior to the other parameters already discussed; i.e., the further the ripening of the fruit progressed, the quantity of phenolic compounds diminished showing a decrease of 38.86% for stage 6 compared with the first stage. In all cases, both in general and individual quantification, the radiation treatment had only a positive effect in increasing the concentration of the compounds during the last stage of ripening. This suggests that in the early stages, the fruit has a more organized and stable cell wall, which could function as a barrier to prevent UV-C light to penetrate. However, mature fruits accumulate a higher water content, which leads to a disruption and solubility of polysaccharides constituting the cell wall, causing a precocious dissolution mainly of the middle lamella (Goulao, et al., 2008). This weakening of the fruit makes it more susceptible to the effect of radiation, allowing easier penetration of UV light into its epidermal cells.

Once the effect of low temperatures and irradiation of the fruit with UV light on the concentration of phenolic compounds was known, the behavior of both treatments was analyzed in different presentations of strawberry according to the present invention. For this purpose, we irradiated 300 whole fruits, 300 half fruits, and the puree from 300 fruits, all of them of the variety “Camino Real.” They were stored at 0° C. and −20° C. and samples were taken at 0, 2, 5, 7 and 9 days of storage. In each case, the total content of flavonoids, anthocyanins, phenolic compounds, and antioxidant capacity was quantified (table 4). The storage temperature had no significant effect on the concentration of flavonoids, phenolic compounds, and antioxidant activity in any of the three presentations in different storage days. However, the concentration of anthocyanins in half fruits (table 4) was altered depending on the storage temperature at different sampling days, being more evident in samples stored at 0° C. This may be owed to the instability of anthocyanins and their susceptibility to suffer structural modifications by the presence of light, oxygen, pH, and acidity, among other factors. The average concentration of all compounds tested showed a variation, which tended to decrease over the days of storage for the presentations of whole and half fruit. Antioxidant capacity remained constant during the nine days and was slightly higher in the whole fruit (2942.66 mM ET) and half fruit (3150 mM ET) compared with the puree (2677.57 mM ET). In the samples from whole fruit, radiation increased the concentration of the quantized parameters only in the first days of storage, while in the remaining days no significant differences were observed. However, in the samples of half fruit and strawberry puree, a statistical increase of the values of the irradiated samples with respect to the control samples was observed during the storage period in all parameters. This indicates that strawberry half fruit and puree presentations are better for to preserve the positive effects from the radiation.

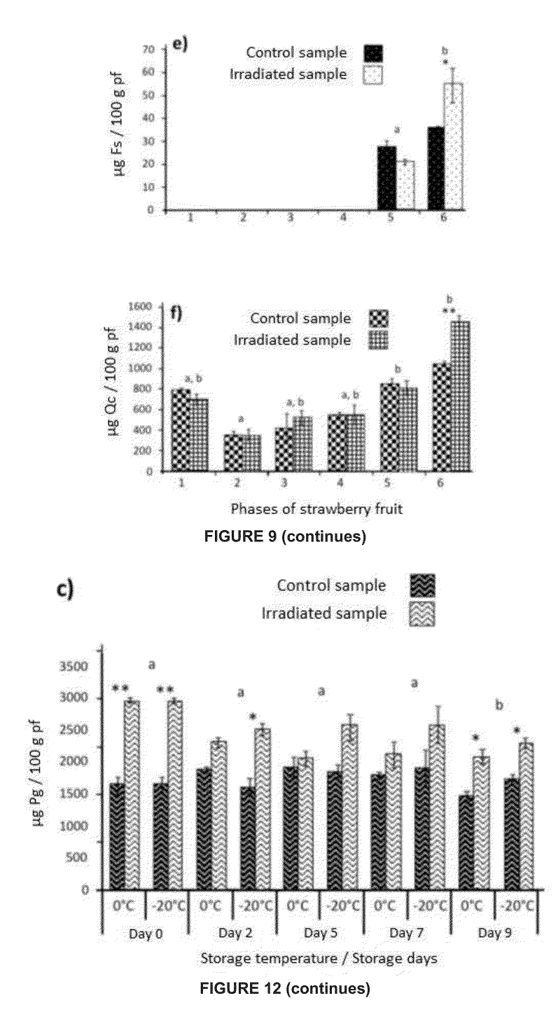

In order to summarize table 4 and determine which presentation and what day of storage show the best increase in the concentration of phenolic compounds achieved by radiation, FIG. 11 indicates the increase percentage of each of the parameters. Based on it, the following was determined:
The highest percentage of increase in the four parameters: flavonoids 29.38% (FIG. 11a), anthocyanins 74.37% (FIG. 11b), phenolic compounds 15.78% (FIG. 11c), and antioxidant capacity 5.5% (FIG. 11d) was obtained on day zero in the presentation of half fruits. This can be explained because in this presentation a larger amount of functional cells (epidermal and subdermal) is exposed, thus producing a wider and better access to the stimulus receptors, which respond by increasing the production of flavonoids, unlike the whole fruit presentation, where only epidermal cells are exposed and the puree presentation, where less whole cells are available for exposition owed to the damage caused by liquefaction.

TABLE 4
Determination of parameters of control samples and irradiated samples
stored for 9 days at 0° C. and −20° C.

| Fruit | Whole | | Half | | Puree | |
|---|---|---|---|---|---|---|
| T (° C.) | 0 | −20 | 0 | −20 | 0 | −20 |

Flavonoids

| | | | | | | | | | | | |
|---|---|---|---|---|---|---|---|---|---|---|---|
| Day | 0 | Control | 17.35 ± | 17.35 ± | a | 16.88 ± | 16.88 ± | a | 18.83 ± | 18.83 ± | a |
| | | | 1.42 | 1.42 | | 2.06 | 2.06 | | 2.79 | 2.79 | |
| | | Irradiated | 21.99 ± | 21.99 ± | | 21.84 ± | 21.84 ± | | 20.24 ± | 20.24 ± | |
| | | | 1.64*** | 1.64*** | | 2.84** | 2.84** | | 1.75** | 1.75** | |
| | 2 | Control | 13.25 ± | 13.76 ± | b | 14.67 ± | 15.31 ± | b | 17.21 ± | 16.93 ± | a |
| | | | 0.92 | 0.62 | | 1.62 | 1.97 | | 3.16 | 2.03 | |
| | | Irradiated | 15.62 ± | 15.16 ± | | 19.74 ± | 18.44 ± | | 18.63 ± | 18.7 ± | |
| | | | 1.08** | 0.79 | | 1.09*** | 1.93 | | 1.23* | 1.5** | |
| | 5 | Control | 16.61 ± | 15.34 ± | c | 16.06 ± | 19.45 ± | a | 18.73 ± | 17.37 ± | a |
| | | | 2.07 | 1.31 | | 0.97 | 1.35 | | 1.82 | 1.01 | |
| | | Irradiated | 20.38 ± | 18.18 ± | | 22.62 ± | 22.28 ± | | 20.26 ± | 19.4 ± | |
| | | | 2.43 | 0.66 | | 1.12*** | 1.44** | | 0.73 | 1.63 | |
| | 7 | Control | 17.88 ± | 18.78 ± | a | 18.99 ± | 14.01 ± | a, b | 18.03 ± | 18.6 ± | a |
| | | | 1.66 | 1.53 | | 1.39 | 1.27 | | 1.83 | 1.63 | |
| | | Irradiated | 21.92 ± | 20.86 ± | | 21.99 ± | 19.12 ± | | 20.37 ± | 20.83 ± | |
| | | | 2.08** | 1.16* | | 2.4 | 1.14*** | | 1.63 | 1.25** | |
| | 9 | Control | 16.8 ± | 14.9 ± | c | 11.1 ± | 15.32 ± | c | 19.64 ± | 18.31 ± | a |
| | | | 1.24 | 1.55 | | 2.08 | 1.09 | | 2.86 | 2.56 | |
| | | Irradiated | 19.42 ± | 17.68 ± | | 18.6 ± | 16.72 ± | | 20.81 ± | 20.3 ± | |
| | | | 6.09 | 1.93 | | 2.03** | 1.28 | | 0.89*** | 1.08** | |

Anthocyanins

| | | | | | | | | | | | |
|---|---|---|---|---|---|---|---|---|---|---|---|
| Day | 0 | Control | 17.35 ± | 17.35 ± | a | 18.57 ± | 18.57 ± | a | 24.8 ± | 24.8 ± | a |
| | | | 1.42 | 1.42 | | 4.63 | 4.63 | | 0.97 | 0.97 | |
| | | Irradiated | 21.99 ± | 21.99 ± | | 39.6 ± | 39.6 ± | | 38.88 ± | 38.88 ± | |
| | | | 1.64* | 1.64* | | 1.29*** | 1.29*** | | 2.8** | 2.8** | |
| | 2 | Control | 13.25 ± | 13.76 ± | a, b | 11.31 ± | 17.55 ± | b, c | 22.65 ± | 21.42 ± | a |
| | | | 0.92 | 0.62 | | 3.12 | 2.62 | | 0.48 | 6.74 | |
| | | Irradiated | 15.62 ± | 15.16 ± | | 22.47 ± | 31.02 ± | | 35.78 ± | 36.03 ± | |
| | | | 1.08 | 0.79 | | 1.81*** | 1.44* | | 2.98*** | 2.01** | |
| | 5 | Control | 16.61 ± | 15.34 ± | b, c | 24.36 ± | 16.86 ± | c | 23.62 ± | 21.42 ± | a |
| | | | 2.07 | 1.31 | | 2.62 | 2.66 | | 2.58 | 1.48 | |
| | | Irradiated | 20.38 ± | 18.18 ± | | 31.02 ± | 21.1 ± | | 37.45 ± | 33.94 ± | |
| | | | 2.43 | 0.66 | | 1.44*** | 1.74* | | 1.33** | 2.26 | |
| | 7 | Control | 17.88 ± | 18.78 ± | c | 29.2 ± | 11.89 ± | b, c | 20.95 ± | 20.54 ± | a |
| | | | 1.66 | 1.53 | | 1.67 | 2.88 | | 2.01 | 5.78 | |
| | | Irradiated | 21.92 ± | 20.86 ± | | 32.21 ± | 13.25 ± | | 32.86 ± | 32.13 ± | |
| | | | 2.08 | 1.16 | | 2.34* | 4.18 | | 1.84** | 1.79 | |
| | 9 | Control | 16.8 ± | 14.9 ± | b, c | 13.71 ± | 14.21 ± | c | 20.98 ± | 20.54 ± | a |
| | | | 1.24 | 1.55 | | 2.87 | 0.66 | | 4.75 | 5.78 | |
| | | Irradiated | 19.42 ± | 17.68 ± | | 27.31 ± | 16.84 ± | | 30.57 ± | 33.12 ± | |
| | | | 6.09 | 1.93 | | 1.29** | 0.73* | | 5.42 | 2.18* | |

Phenolic compounds

| | | | | | | | | | | | |
|---|---|---|---|---|---|---|---|---|---|---|---|
| Day | 0 | Control | 307.045 ± | 307.045 ± | a | 250.17 ± | 250.17 ± | a, c | 233.34 ± | 233.34 ± | a |
| | | | 18.91 | 18.91 | | 3.6 | 3.6 | | 11.52 | 11.52 | |
| | | Irradiated | 349.86 ± | 349.86 ± | | 289.67 ± | 289.67 ± | | 261.64 ± | 261.64 ± | |
| | | | 7.49* | 7.49* | | 5.61*** | 5.61*** | | 7.14** | 7.14** | |
| | 2 | Control | 306.87 ± | 286.57 ± | b | 249.65 ± | 252.3 ± | a, b | 248.51 ± | 238.27 ± | a |
| | | | 22.81 | 8.46 | | 33.19 | 14.98 | | 7.69 | 1.37 | |
| | | Irradiated | 318.06 ± | 297.7 ± | | 297.83 ± | 254.45 ± | | 271.65 ± | 285.82 ± | |
| | | | 4.8 | 33.46 | | 7.34 | 16.7 | | 1.6** | 12.05* | |
| | 5 | Control | 284.62 ± | 286.64 ± | b | 275.26 ± | 263.81 ± | c | 240.29 ± | 251.67 ± | a |
| | | | 14.02 | 8.7 | | 1.34 | 5.32 | | 9.7 | 7.83 | |
| | | Irradiated | 314.77 ± | 296 ± | | 291.57 ± | 286.45 ± | | 291.63 ± | 255.02 ± | |
| | | | 12.37* | 34.31 | | 11.7* | 17.47 | | 1.7** | 18.78 | |
| | 7 | Control | 274.74 ± | 302.38 ± | b | 244.65 ± | 257.24 ± | a, b | 268.05 ± | 259.17 ± | a |
| | | | 8.82 | 7.41 | | 12.92 | 10.22 | | 11.53 | 0.79 | |
| | | Irradiated | 295.93 ± | 324.51 ± | | 270.72 ± | 284.42 ± | | 281.39 ± | 271.28 ± | |
| | | | 2.73 * | 9.00 | | 9.64* | 16.79 | | 6.54 | 0** | |
| | 9 | Control | 285.72 ± | 301.51 ± | b | 253.03 ± | 251.04 ± | b | 253.69 ± | 265.77 ± | a |
| | | | 7.02 | 2.33 | | 17.04 | 7.27 | | 6.45 | 2.94 | |
| | | Irradiated | 294.95 ± | 293.17 ± | | 277.47 ± | 266.72 ± | | 264.19 ± | 276.96 ± | |
| | | | 3.4* | 18.63 | | 4.39* | 12.88 | | 3.73* | 32.66* | |

Antioxidant capacity

| | | | | | | | | | | | |
|---|---|---|---|---|---|---|---|---|---|---|---|
| Day | 0 | Control | 2931.69 ± | 2931.69 ± | a | 3114.15 ± | 3114.15 ± | a | 2653.84 ± | 2653.84 ± | a |
| | | | 13.51 | 13.51 | | 10.16 | 10.16 | | 17.34 | 17.34 | |
| | | Irradiated | 3020.63 ± | 3020.63 ± | | 3288.45 ± | 3288.45 ± | | 2736.53 ± | 2736.53 ± | |
| | | | 35.05* | 35.05* | | 13.59** | 13.59** | | 5.43** | 5.43** | |
| | 2 | Control | 2967.3 ± | 2867.3 ± | a | 3132.68 ± | 3125.95 ± | a | 2674.99 ± | 2630.76 ± | a |
| | | | 161.91 | 157.5 | | 12.16 | 15.18 | | 31.4 | 13.13 | |
| | | Irradiated | 3003.2 ± | 3059.61 ± | | 3282.66 ± | 3208.45 ± | | 2726.91 ± | 2705.76 ± | |
| | | | 28.86* | 85.65 | | 10.84 | 91.03 | | 38.78 | 16.31*** | |
| | 5 | Control | 2883.37 ± | 2883.37 ± | a | 3074.99 ± | 3119.22 ± | a | 2634.61 ± | 2619.22 ± | a |
| | | | 115.26 | 139.11 | | 35.08 | 14.56 | | 47.98 | 46.23 | |
| | | Irradiated | 2995.93 ± | 3004.48 ± | | 3181.72 ± | 3160.57 ± | | 2700.95 ± | 2702.88 ± | |
| | | | 53.7 | 65.08 | | 94.69 | 80.21 | | 61.32 | 26.53 | |
| | 7 | Control | 2857.04 ± | 2848.07 ± | a | 3069.22 ± | 3097.11 ± | a | 2667.3 ± | 2626.76 ± | a |
| | | | 247.66 | 123.38 | | 21.28 | 77.64 | | 60.32 | 53.11 | |
| | | Irradiated | 3021.15 ± | 3041.66 ± | | 3190.38 ± | 3196.14 ± | | 2732.68 ± | 2707.68 ± | |
| | | | 63.55* | 76.37 | | 75.3 | 89.62 | | 18.78 | 32.85 | |
| | 9 | Control | 2857.04 ± | 2799.35 ± | a | 3097.11 ± | 3088.45 ± | a | 2650.63 ± | 2605.76 ± | a |
| | | | 13.51 | 176.18 | | 46.83 | 24.82 | | 32.71 | 32.63 | |
| | | Irradiated | 3005.75 ± | 3035.23 ± | | 3200.45 ± | 3211.53 ± | | 2731.4 ± | 2705.76 ± | |
| | | | 35.05 | 74.21 | | 92.38 | 98.43 | | 27.82* | 35.94* | |

Different letters indicate a significant difference between storage days, (ANOVA-Tukey) p <= 0.05, n = 3
*Indicates significant difference p <= 0.05,
**p <= 0.01 and
***p <= 0.001, by radiation treatment.

The content of anthocyanins and flavonoids increased during the nine days of storage at low temperatures in the half fruits irradiated. The irradiated strawberry puree maintained a significant increase of anthocyanins and phenolic compounds during the storage period.
The presentations that show higher increases in the antioxidant capacity of strawberry fruit are half fruits and puree.

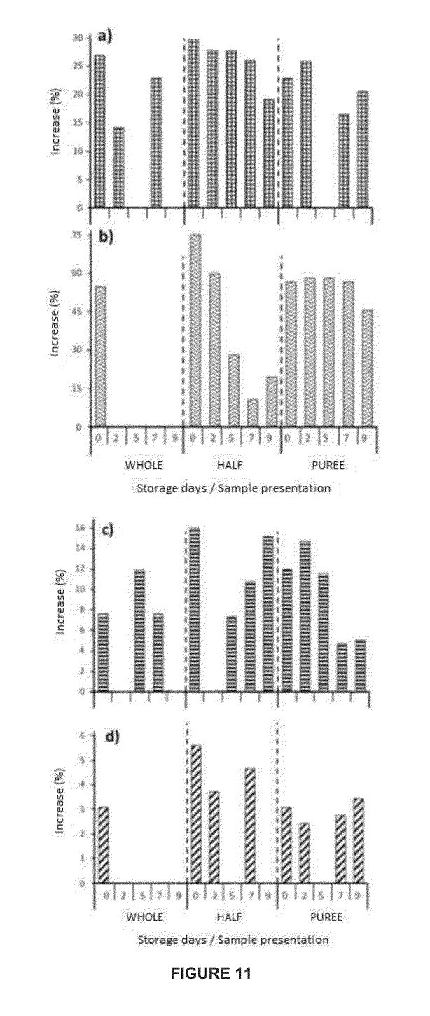

For the individual analysis of fisetin, quercetin and pelargonidin, a single graph per metabolite is portrayed corresponding to the average of the values obtained in the three different presentations of the sample, as no significant difference was observed in the concentration of the compounds regarding the presentation. FIG. 12 show that the amounts of quercetin and pelargonidin exhibit a slight variation with each passing day; unlike fisetin, which remains stable for the nine days of storage at both freezing temperatures. For the three cases, the radiation had only positive effect in the first days of storage, showing a 51% increase for fisetin (FIG. 12a), 31% for quercetin (FIG. 12b) and 72% for pelargonidin (FIG. 12c).

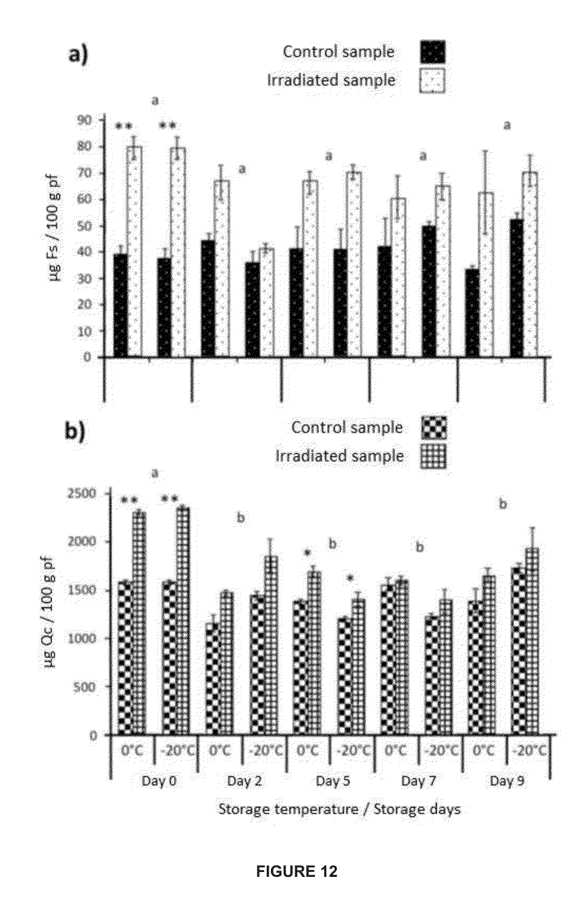

Other compounds that contribute to the antioxidant capacity of strawberry fruit are, for example, vitamin E (alpha-tocopherols), carotenoids (β-carotenoids), lutein, zeaxanthin, and ascorbic acid (Pallauf et al., 2007). Vitamin E was also analyzed in whole fruit, half fruit and strawberry puree both in control samples and samples irradiated with a dose of 2.0 kJ/m². Graphically (FIG. 13), there is a decrease in the content of ascorbic acid in the samples treated, but this difference was not statistically significant. However, the presentation of the sample had a significant effect in the concentration of the compound. Whole fruit and half fruit showed similar concentrations averaging 150 mg ascorbic acid/100 g pf, while strawberry puree showed a significant decrease in its concentration (83%), reducing to 25 mg ascorbic acid/100 g mp. This indicates that the strong damage caused by liquefaction has a direct impact on the decrease of the vitamin C concentration, probably caused by the cell disruption and structural deterioration, or by the strong incorporation of oxygen causing the oxidation of ascorbic acid, transforming it in dehydroascorbic acid. This probably accounts for the lower antioxidant capacity quantified in the strawberry puree unlike the other presentations analyzed.

### REFERENCES

Baka, M., et. al. 1999. Journal of Food Science 64: 1068-1072.
Bird, T., et. al. 1992. Cytokine 4: 429-440.
Brand-Williams W., et. al. 1995. Food science and technology 28: 25-30.
Capdeville, G., et. al. 2002. Phytopathology 92: 900-908.
Cisneros-Zevallos, L. 2003. Journal of Food Science 68: 1560-1565.
Dong, Y., et. al. 1995. Journal of American Society for Horticultural Science 120: 95-100.
Duarte, J., et. al. 2001. Studies in Natural Products Chemistry 25: 565-605.
Duthie, G. D., et. al. 2003. Proceedings of the Nutrition Society 62: 599-603.
Espinosa-Alonso, L., et. al. 2006. Journal of Agricultural and Food Chemistry 54: 4436-4444.
Fang, F., et. al. 2007. Food Chemistry 101: 428-433.
Fazeelat, T., et. al. 2007. Journal of the Chemical Society of Pakistan 29: 243-246.
Gonzalez-Aguilar, G., et. al. 2001. Journal of Food Science and Technology 36: 767-773.
Gonzalez-Aguilar, G., et. al. 2006. Simposium Ibero-Americano de Vegetales Frescos cortados. pp. 59-64.
Gonzalez-Aguilar, G., et. al. 2007. Postharvest Biology and Technology 45: 108-116.
Graefe, E., et. al. 1999. International Journal of Clinical Pharmacology and Therapheutics 37:219-233.
Gruda Zbigniew, et. al. 1986. Tecnología de congelación de los alimentos”. Aribia 631.
Haddad, A., et. al. 2006. Prostate Cancer Prostatic Diseases 9: 68-76.
Hagiwara, A., et. al. 2002. Journal of Toxicological Sciences 27: 57-68.
Havsteen, B. 1983. Biochemical Pharmacology 32: 1141-1148.
Joseph, J., et. al. 1999. Journal of Neuroscience 19: 8114-8121.
Jung, Y-H., et. al. 2010. Life Sciences 86: 351-357.
Kamei, H., et. al. 1998. Cancer Biotherapy Radiopharmaceuticals 13: 447-452.
Khan, N., et. al. 2008. Cancer Research 68: 8555-8563.
Kim, Y-H., et. al. 2007. Journal of Cellular Biochemistry 100: 998-1009.
Kinay, P., et. al. 2005. Postharvest Biology and Technology 37: 31-36.
Koide, T., et. al. 1997. Cancer Biotherapy and Radiopharmaceuticals 12: 277-280.
Lu, X., et. al. 2005. Journal of Nutrition 135: 2884-2890.
Maher, P., et. al. 2006. Proceedings of the National Academy of Sciences USA 103: 16568-16573.
Mane, C., et. al. 2007. Journal of Agricultural and Food Chemistry 55: 7224-7233.
Mercier, J., et. al. 1993. Journal of Phytopathology 139: 17-35.
Mustafa, E., et. al. 2008. Postharvest Biology and Technology 48: 163-171.
Nigro, F., et. al. 1998. Postharvest Biology and Technology 13: 171-181.
Nigro, F., et. al. 2000. Journal of Plant Pathology 82: 29-37.
Ohgami, K., et. al. 2005. Investigative Ophthalmology and Visual Science 46: 275-281.
Pallauf, K., et. al. 2007. Journal of Food Composition and Analysis 21: 273-281.
Pan, J., et. al. 2004. Journal of the Science of Food and Agriculture 84: 1831-1838.
Perkins-Veazie, P., et. al. 2008. Postharvest Biology and Technology 47: 280-285.
Rice-Evans, C., et. al. 1997. Trends in Plant Science 2: 152-159.
Stevens, C., et. al. 1998. Crop Protection 17: 75-84.
Stevens, C., et. al. 2004. Crop Protection.23: 551-554.
Tristan, F., et. al. 2005. Journal of Food Science 70: S159-S166.
Vessal, M., et. al. 2003. Comparative Biochemistry and Physiology Part C: Toxicology and Pharmacology Part C 135: 357-364.
Vicente, A., et. al. 2005. Postharvest Biology and Technology 35: 69-78.
Vuorela, S., et. al. 2005. Journal of Agricultural and Food Chemistry 53: 5922-5931.
Wang, J. et. al. 2002. Journal of Agricultural and Food Chemistry 50: 850-857.
World Health Organization. 1959. http://www.who.int/es/
WCRF: World Cancer Research Fund International. 1997. http://www.wcrf.org/

We claim:

1. A method of increasing the content of antioxidant compounds such as flavonoids, phenols, and anthocyanins in perishable fruits, characterized because comprising the steps of:
a) Irradiating the fruit with ultraviolet light with a light intensity of 0.5 to 4.0 kJ/m² for 7 to 56 minutes; and
b) Subjecting the irradiated fruit at a temperature of 0° C. or −20° C., for a period of up to 9 days.

2. The method according to claim 1, characterized because the light intensity is 2.0 kJ/m².

3. The method according to claim 1, characterized because the irradiation time is 28 minutes.

4. The method according to claim 1, wherein the ultraviolet light has a wavelength of 100 to 400 nm.

5. The method according to claim 1, characterized because the freezing temperature is below than 0° C.

6. The method according to claim 1, characterized because the fruit contains anthocyanins, phenolics and flavonoids.

7. The method according to claim 6, wherein the fruit is selected from the group comprising raspberry, blueberry, blackberry, strawberry, wild cherry or capuli and grape.

8. The method according to claim 1, characterized because the perishable fruit has a presentation selected from the group comprising whole fruit, half fruit and puree.

9. A perishable fruit with an increased content of antioxidant compounds such as flavonoids, phenols, and anthocyanins, characterized because is obtained with the method of the claim 1.
